(19) United States
(12) Patent Application Publication
(10) Pub. No.: US 2018/0266835 A1
(43) Pub. Date: Sep. 20, 2018

(54) NAVIGATION SYSTEM, USER TERMINAL, AND NAVIGATION METHOD

(71) Applicant: HONDA MOTOR CO., LTD., Tokyo (JP)

(72) Inventor: Miyuki Shimota, Wako-shi (JP)

(73) Assignee: HONDA MOTOR CO., LTD., Tokyo (JP)

(21) Appl. No.: 15/925,026

(22) Filed: Mar. 19, 2018

(30) Foreign Application Priority Data
Mar. 17, 2017 (JP) 2017-052055

(51) Int. Cl. G01C 21/34; G01C 21/36; H04W 4/12

(52) U.S. Cl. CPC G01C 21/3438; G01C 21/3635; G01C 21/20; G01C 21/3676; H04W 4/12; G01C 21/362

(57) ABSTRACT

A navigation system includes: a guidance unit that sets, when a first user selects a second user, any of a location of the second user thus selected and the vicinity of the second user as a destination, and outputs, to the first user, guidance information for guiding the first user to the destination thus set; and a notification unit that notifies, when the destination is set, the second user of information on travel means that the first user uses to get to the destination.

### CROSS-REFERENCE OF RELATED APPLICATION

This application claims priority of Japanese Patent Application No. 2017-052055 filed in Japan on Mar. 17, 2017, the entire contents of which are incorporated herein by reference.

### TECHNICAL FIELD

The present invention relates to a navigation system, a user terminal, and a navigation system for guiding users who will meet up, for example.

### BACKGROUND ART

A navigation system has heretofore been known in which, once a destination is set in a mobile terminal, such as a mobile phone of a smartphone, or an in-vehicle device, the system guides a User by outputting information on a route to the destination to the user. In the case of using such a navigation system, a user can smoothly meet up with a person with whom he/she communicates (person to communicate with) if the location of this person is set as a destination.

For example, examples of a technique of utilizing a navigation system for meeting up with a person to communicate with in the above manner are disclosed in Japanese Patent Application Publication Nos. 2008-085945, 2006-184083 and 2003-329478.

Specifically, the technique disclosed in Japanese Patent Application Publication No. 2000-085945 is a system that helps group members to meet up. The system acquires the present location of each member from a mobile terminal device carried by the member, and searches for a route to a set meeting location and displays it on a map.

Meanwhile, the technique disclosed in Japanese Patent Application Publication No. 2006-184083 is a navigation system that sets the present location of a mobile communication terminal as a destination. In the system, a car navigation device makes a searching notification to a person who holds the mobile communication terminal, and displays a route to the mobile communication terminal if the searching is approved.

Meanwhile, the technique disclosed in Japanese Patent Application Publication No. 2003-329478 is a system that can display the location of a mobile phone, equipped with a global positioning system (GPS) function, on a mobile terminal device. Upon designation a person from among those previously registered in a record part, the system displays a map including a route to the person.

The use of techniques such as those disclosed in the background art enables users to meet smoothly.

However, common techniques including the techniques disclosed in these patent documents can just provide route guidance to a meeting spot, and thus another technique for allowing users to meet more smoothly is required.

There is a need of, in consideration of the above circumstances, providing a navigation system, a user terminal, and a navigation method that enable users to meet up more smoothly than ever.

### SUMMARY OF INVENTION

(1) A navigation system (a navigation system 1 to be described, later, for example) according to one embodiment of the present invention includes: a guidance unit (a guidance unit 111 to be described later, for example) that sets, when a first user selects a second user, any of a location of the second user thus selected and the vicinity of the second user as a destination, and outputs, to the first user, guidance information for guiding the first user to the destination thus set; and a notification unit (a notification unit 112 to be described later, for example) that notifies, when the destination is set, the second user of information on travel means that the first user uses to get to the destination.

(2) The navigation system described in the item: (1) above may be a navigation system such that, in the information to be notified, on the travel means that the first user uses to get to the destination, the notification unit includes information on visual characteristics of the travel means.

(3) The navigation system described in the item (1) or (2) above may be a navigation system such that, when a stop-off point where the first user stops off before arriving at the destination is set, the notification unit notifies any of or both of the first user and the second user of recommendation information on a location that, is near the stop-off point and suitable for the users to meet up.

(4) The navigation system described in the item (3) above may be a navigation system such that the stop-off point is a location located on a route by which the first user gets to the destination, and is a location at which the first user changes the travel means to different travel means.

(5) The navigation system described in the item (3) or (4) above maybe a navigation system such that, when the location near the stop-off point and suitable for the users to meet up is set as a new destination, the guidance unit outputs, to the first user, guidance information for guiding the first user to the new destination, and outputs, to the second user, guidance information for guiding the second user to the new destination, and the notification unit outputs, to the first user, information on travel means that the second user uses to get to the new destination, and outputs, to the second user, information on travel means that the first user uses to get to the new destination.

(6) The navigation system described in any of the items (1) to (5) above may be a navigation system such that the notification unit estimates the time required for each of the first user and the second user to arrive at the destination and, when the remaining time required for the first user to arrive at the destination becomes equal to that required for the second user to arrive at the destination by movement of one of the first user and the second user, gives the other user a notification prompting movement to the destination.

(7) A user terminal (a first user terminal 10 to be described later, for example) according to another embodiment of the present invention is a user terminal used by a first user including: a guidance unit (the guidance unit 111 to be described later, for example) that sets, when the first user selects a second user, any of a location of the second user thus selected and the vicinity of the second user as a destination, and outputs, to the first user, guidance information for guiding the first user to the destination thus set; and a notification unit (the notification unit 112 to be described later, for example) that notifies, when the destination is set, a second user terminal (a second user terminal 10 to be described later, for example), which is used by the second user, of information on travel means that the first user uses to get to the destination.

(8) A navigation method according to another embodiment of the present invention is a navigation method executed by a navigation system (the navigation system 1 to be described later, for example), the method including: a guidance step of setting, when a first user selects a second user, any of a location of the second user thus selected and the vicinity of the second user as a destination, and output ting, to the first user, guidance information for guiding the first user to the destination thus set; and a notification step of outputting, when the destination is set, information on travel means that the first user uses to get to the destination, to the second user. The word “unit” used in this application may mean a physical part or component of computer hardware or any device including a controller, a processor, a memory, etc., which is particularly configured to perform functions and steps disclosed in the application.

### Effect of Embodiments of the Invention

The embodiments according to the present invention enables users to meet up more smoothly than ever.

### BRIEF DESCRIPTION OF THE DRAWINGS

FIG. 1 is a diagram illustrating the entire basic configuration of an embodiment of the present invention.

FIG. 2 is a block diagram illustrating functional blocks of a user terminal in the embodiment of the present invention.

FIG. 3 is a flowchart illustrating a basic operation of the embodiment of the present invention.

FIG. 4 is a diagram illustrating an example of a screen to select a person, whom a user will meet, in the embodiment of the present invention.

FIG. 5 is a diagram illustrating an example of a guidance information output screen in the embodiment of the present invention.

FIG. 6 is a diagram illustrating an example of a meeting information output screen in the embodiment of the present invention.

FIG. 7 is a diagram illustrating an example of a stop-off point selection screen and a recommendation information output screen in the embodiment of the present invention.

### DETAILED DESCRIPTION OF EMBODIMENTS OF THE INVENTION

### Embodiments of Present Invention

First, an outline of an embodiment of the present invention is described. In the case where a first user and a second user will meet up using a navigation system, when one user (first user) sets the position of the other user (second user), with whom the first user communicates, as his/her destination, the embodiment of the present invention no cities the second user of what is travel means of the first user.

This enables the second user to know what kind of travel means the first user uses to come to a meeting spot, and thus enables them to meet up more smoothly than ever.

That is the outline of the embodiment of the present invention.

Next, the embodiment of the present invention is described in detail with reference to the drawings.

### Entire Configuration of Embodiment

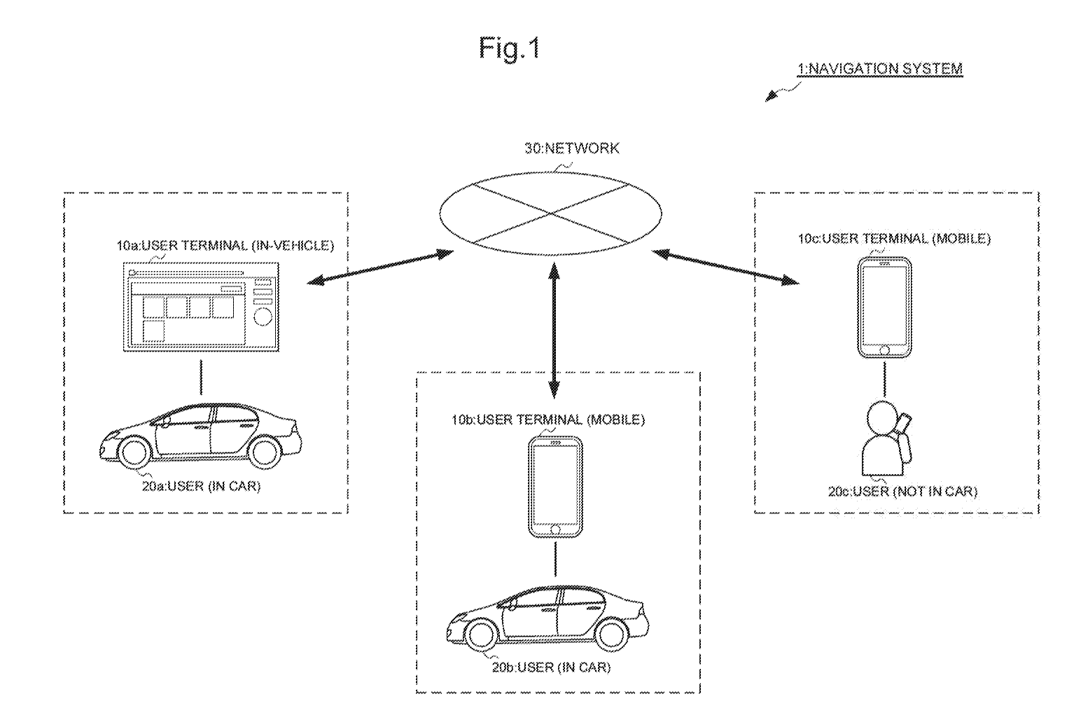

As illustrated in FIG. 1, a navigation system 1 is constituted of: multiple user terminals 10; multiple users 20 that use the multiple user terminals 10; and a network 30 for allowing the multiple users 20 to communicate with each other.

Here, the user terminals 10 may be implemented by an in-vehicle terminal as illustrated as a user terminal 10a, or may be implemented by a mobile terminal as illustrated as a user terminal 10b and a user terminal 10c. In addition, the users 20 may use the user terminals 10 while they are in movable bodies as illustrated as a user 20a and a user 20b, or may use the user terminals 10 while they are not in movable bodies as illustrated as a user 20c. Further, any movable body such as automobiles, motorcycles, bicycles, buses, and trains may be used as the movable bodies.

More specifically, when the user terminals 10 are in-vehicle devices such as the user terminal 10a, the user terminals 10 may be implemented by car navigation systems installed, in the movable bodies, or by portable navigation devices (PNDs) simply set in the movable bodies. On the other hand, when the user terminals 10 are mobile terminals such as the user terminal 10b and the user terminal 10c, the user terminals 10 maybe implemented by smartphones, mobile phones, tablet terminals, PNDs, notebook PCs, or other mobile electronic equipment.

In either case, the user terminals 10 have a radio communication function, and communicate with each other via the network 30. In addition, a navigation (route guidance) software is installed in each user terminal 10, and provides route guidance from a present location to a destination upon user's request. Besides, a meeting information notification software is installed in each user terminal 10, and executes meeting information notification processing to be described later.

The network 30 is implemented by a network such as the Internet, a mobile network, or a local area network (LAN), or a network obtained by their combination.

<Functional Block Equipped in User Terminal 10>

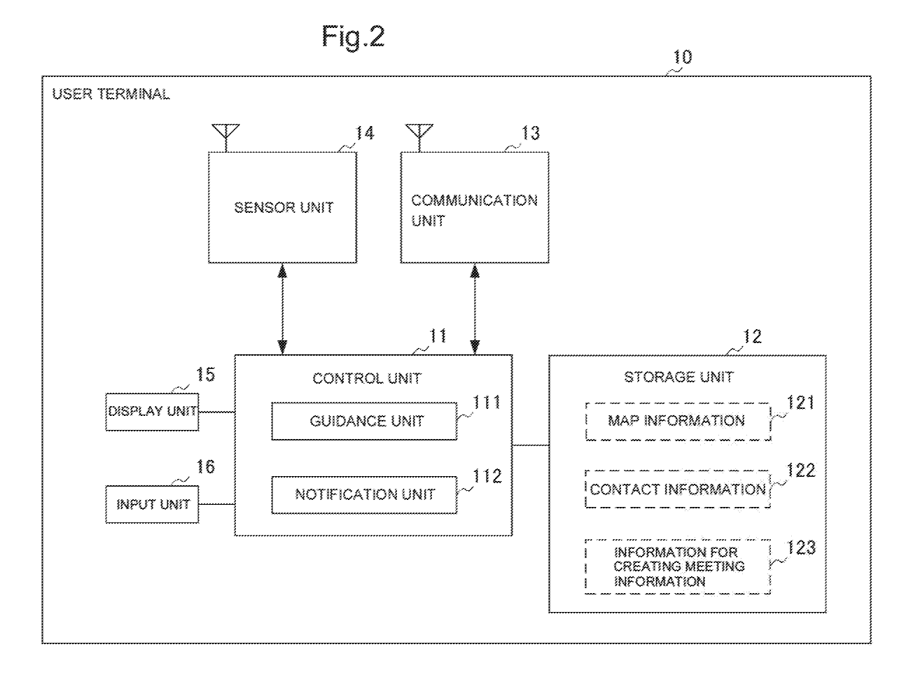

Next, functional blocks equipped in each user terminal 10 are described with reference to the block diagram in FIG. 2. Note that each user terminal 10 has the same functional blocks irrespective of whether the user terminal 10 is implemented by an in-vehicle terminal or by a mobile terminal. Thus, the following description is made with no distinction between an in-vehicle terminal and a mobile terminal, i.e., with alphabets at the end of their reference numerals omitted.

As illustrated in FIG. 2, the user terminal 10 can include at least: a control unit 11; a storage unit 12; a communication unit 13; a sensor unit 14; a display unit 15; and an input unit 16.

The control unit 11 is constituted of an arithmetic processing unit such as a microprocessor, and configured to control the units constituting the user terminal 10. The control unit 11 is described in detail later.

The storage unit 12 is constituted of a semiconductor memory or the like, and stores therein an operating system (OS), programs for route guidance processing and meeting information notification processing, and other various information. Illustrated in the drawing are map information 121, contact information 122, and information for creating meeting information 123 that are information particularly relevant to description of the route guidance processing and the meeting information notification processing.

Here, the map information 121 is general map information for route guidance, and also includes information such as facility information. In addition, the contact information 122 is information that includes the contact address of a person whom the user will meet. Further, the information for creating meeting information 123 is information used to create meeting information in the meeting information notification processing, and includes information such as travel means that the users 20 use. These three kinds of information are described in detail later.

These information stored in the storage unit 12 may be stored in the storage unit 12 in advance, or may be downloaded as needed from a server apparatus (not illustrated) connected to the network 30. In addition, the information such as the information for creating meeting information 123 may be modified as needed, according to user's input, for example.

The communication unit 13 has a digital signal processor (DSP) and the like, and is compliant with standards such as 3rd Generation (3G), Long Terra Evolution (LTE), and Wi-Fi to implement radio communications with another user terminal 10 via the network 30. Data that are exchanged with another user terminal 10 by the communication unit 13 are not particularly limited. For example, meeting information to be described later is exchanged with another user terminal 10.

The sensor unit 14 is constituted of sensors, such as a global positioning system (GPS) sensor, a gyro sensor, and an acceleration sensor. The sensor unit 14 has a function of a location detection unit that detects a present location, and is configured to measure the present location (latitude and longitude) of the user terminal 10 in response to receipt of a GPS satellite signal from the GPS sensor. Here, the present location of the user terminal 10 corresponds to the present location of the user 20 who is using this user terminal 10.

Note that it is also possible to enhance the accuracy of the sensor unit 14 in the measurement of the present location of the user terminal 10 based on an angular velocity and acceleration measured by the gyro sensor and acceleration sensor.

In addition, when GPS communications become difficult or unavailable, the sensor unit 14 can also use assisted global positioning system (AGPS) communications and calculate the present location of the user terminal 10 from base station information acquired from the communication unit 13.

The display unit 15 is constituted of a display device such as a liquid crystal display or an organic electroluminescence panel. The display unit 15 is configured to display thereon an image in response to instruction from the control unit 11. Examples of information to be displayed on the display unit 15 include: the present location of the user terminal 10; map information around the present location of the user terminal 10 that is read from the map information 121; a destination set by the user 20; meeting information notified by another user terminal 10; route information; and various user interfaces.

The input unit 16 is constituted of, for example, an input device (not illustrated) such as physical switches called a ten key or a touch panel laid on the display screen of the display unit 15. The input unit enables the user 20 to perform operations such as selection and scaling of the map by outputting to the control unit 11 a signal generated based on an input through manipulation of the input unit 16, e.g., press of the ten key or touch on the touch panel by the user 20.

Note that, although not illustrated, the user terminal may also include a speaker, a microphone, and the like. The speaker is configured to output sounds to a driver, and the microphone is configured to collect sounds such as voice output from the driver.

This makes it possible to output information from the speaker by audio and, by use of voice recognition technology, input to the control unit 11 various selections and instructions that are input by the driver (or the user) through the microphone.

Next, the control unit 11 is described in detail. The control unit 11 is constituted of a microprocessor including a central processing unit (CPU), a random access memory (RAM), a read only memory (ROM), an input/output (I/O), and the like. The CPU is configured to execute programs read from the ROM or the storage unit 12, retrieve information from the RAM, the ROM, and the storage unit 12 when executing the programs, write information to the RAM and the storage unit 12, and exchange signals among the communication unit 13, the sensor unit 14, the display unit 15, and the input unit 16. Such collaboration between hardware and software (programs) implements the processing in this embodiment.

The control unit 11 includes a guidance unit 111 and a notification unit 112 as its functional blocks.

The guidance unit 111 is a part configured to perform the route guidance processing to a destination, such as a facility, input or selected by the user, or to a destination in the meeting information notification processing to be described later (i.e., meeting spot).

The processing of route guidance to a destination can be implemented in the same manner as processing of route guidance to a destination in general car navigation systems. Specifically, this processing can be performed by creating a map to a destination based on the map information 121, superimposing the present location of the user terminal 10 measured by the: sensor unit 14, the location of the destination, and route information to the destination onto this map, and displaying it on the display unit 15. In this case, it is also possible to output, route guidance voice through the microphone (not illustrated). Besides, it is also possible to acquire information such as traffic congestion information and weather information through communications via the communication unit 13 and use the acquired information for the route guidance processing.

Note that, since such processing of route guidance to a destination is well known to those skilled in the art, a more detailed description is omitted here.

The communication unit 112 is a part configured to perform the meeting information notification processing which is processing unique to this embodiment. The meeting information notification processing is described in detail next.

<Meeting Information Notification-Processing>

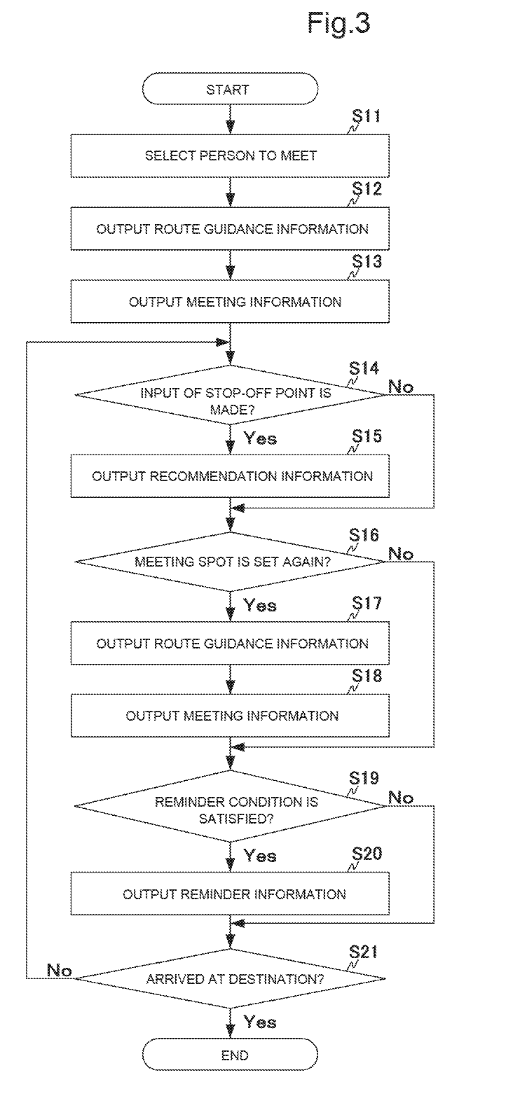

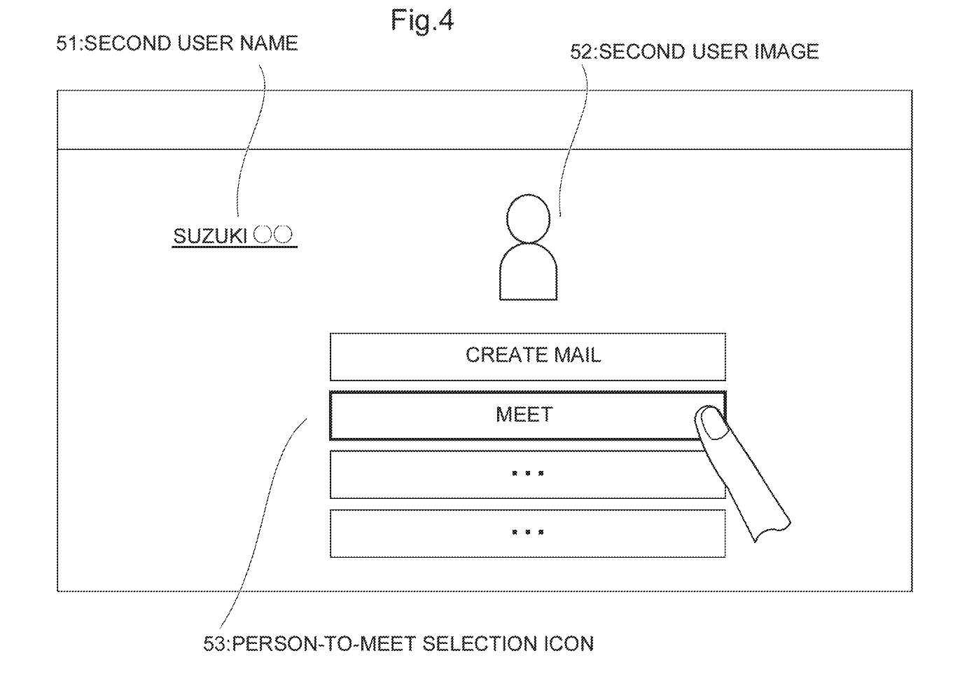

The functions of the user terminal 10 included in this embodiment have been described above. Next, the meeting information notification processing is described in detail with reference to the flowchart of FIG. 3 and the screen display examples illustrated in FIGS. 4 to 7.

The description is made based on the premises that: one user 20 (first user 20) has suggested to the other user 20 (second user 20) that they meet up; the first user 20 uses the first user terminal 10 whereas the second user 20 uses the second user terminal 10; and the first user 20 is riding on a bicycle whereas the second user 20 is at a restaurant. Mote that these premises are shown merely for the purpose of explanation and not for limiting situations where this embodiment is applicable.

First, the first user terminal 10 accepts the first user 20's selection of a person whom the first user will meet (person to meet) (Step S11). For this purpose, the notification unit 112 of the first user terminal 10 retrieves the contact information 122 from the storage unit 12 of the first user terminal 10 and creates a person-to-meet selection screen. Then, the notification unit displays the person-to-meet selection screen thus created on the display unit 15 of the first user terminal 10.

Here, the contact information 122 is information equivalent to a so-called address book, and includes: contact information (e.g., mail address, telephone number) of persons who can be a person to meet, e.g., family members and friends; image data of the family members and friends; and so on. The contact information 122 also includes identification information for allowing the notification units 112 of the user terminals 10 in this embodiment to communicate with each other via the communication units 13 of the user terminals 10. Examples of the identification information include IP address information for identifying the person to meet and information for IP address resolution. Note that the communications via the network 30 between the notification units 112 of the user terminals 10 may be performed by means of Peer to Peer or Client-Server method via the server.

For the person-to-meet selection screen displayed on the display unit 15, a list of persons, e.g. family members and friends, who can be a person to meet is first displayed. Then, once the first user 20 selects a user (the second user 20 this time) from the list as a person to meet, the guidance unit ill further displays a screen as illustrated in FIG. 4.

As illustrated in FIG. 4, a second user name 51, a second user image 52, and a person-to-meet selection icon 53 are displayed on this screen. When the first user 20 creates an email or makes a phone call to the second user 20, he/she presses icons corresponding to these processes. Meanwhile, when the first user 20 selects the second user 20 as a person to meet, he/she presses the person-to-meet selection icon 53. Upon accepting the press of the person-to-meet selection icon 53, the process proceeds to Step S12.

Next, the first user terminal 10 outputs route guidance information (Step S12). To this end, the notification unit 112 of the first user terminal 10 inquires of the notification unit 112 of the second user terminal 10 about the present location of the second user terminal 10.

The notification unit 112 of the second user terminal 10 having received the inquiry acquires the present location of the second user-terminal 10 measured by the sensor unit 14 of the second user terminal 10 and sends it back to the notification unit 112 of the first user terminal 10. From the perspective of reflecting the second user 20's wish, it is preferable that the second user terminal 10 send its present location back to the notification unit 112 of the first user terminal 10 only when the second user 20 permits or previously permits sending of location information through manipulation.

Note that, in the above description, when the first user 20 presses the person-to-meet selection icon 53 in Step S11, the process proceeds to Step S12 and the second user terminal 10 sends its present location back to the notification unit 112 of the first user terminal 10. Instead, it is also possible that the second user terminal 10 first sends its present location to the notification unit 112 of the first user terminal 10, and then the first user 20 of the first user terminal 10 selects whether to press the person-to-meet selection icon 53 while referring to the present location of the second user terminal 10. Note that, in this case, it is also preferable that the second user terminal 10 send its present location only when the second user 20 permits or previously permits sending of location information through manipulation.

The notification unit 112 of the first user terminal 10 sets the present location of the second user terminal 10 thus received as a destination (meeting spot), and instructs the guidance unit 111 of the first user terminal 10 to create route guidance information. In response to this instruction, the guidance unit 111 of the first user terminal 10 creates route guidance information and displays the generated route guidance information on the display unit 15 of the first user terminal 10.

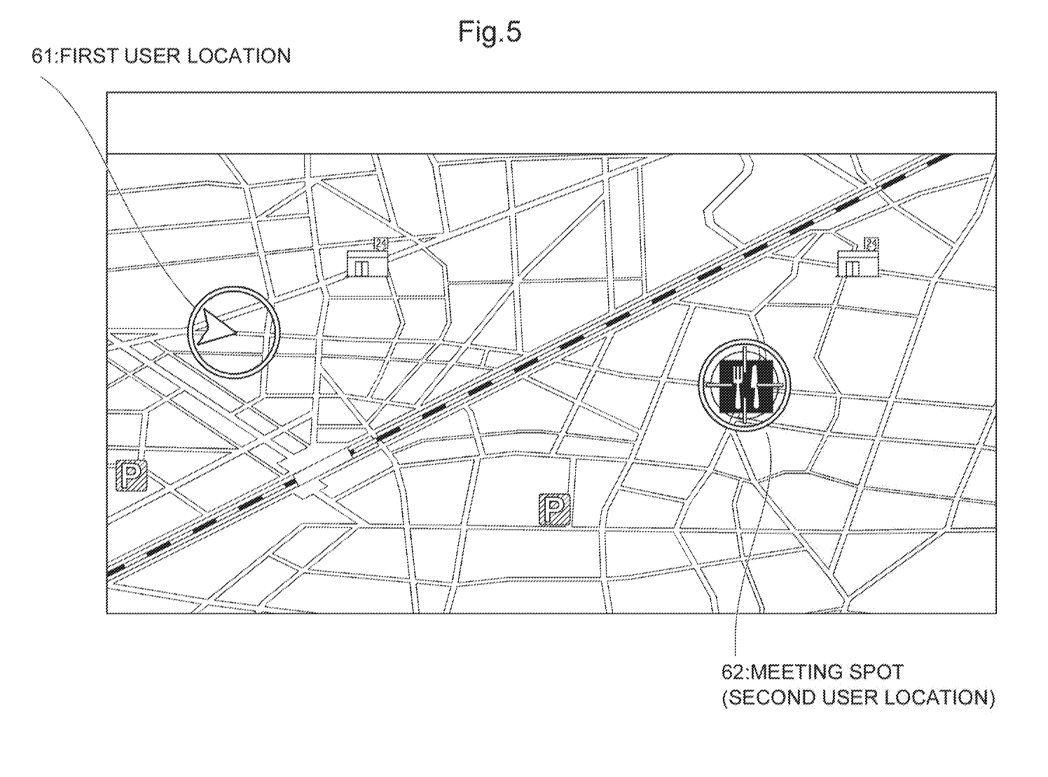

A display example of this route guidance information is described with reference to FIG. 5.

As illustrated in FIG. 5, the route guidance information is implemented by an image obtained by superimposing the present location of the first user terminal 10 as a first user location 61 and the present location of the second user terminal 10 as a meeting spot 62 one on top of the other on the map to a destination. Note that, for the meeting spot, the exact present location of the second user terminal 10 may be set as the meeting spot; alternatively, if it can be judged that the second user 20 is at a facility, such as a cafe, when checking the present location of the second user terminal 10 against map information, that facility (i.e., vicinity of the second user 20) may be set as the meeting spot. In addition, although not illustrated, route information to the meeting spot 62 may be further superimposed on the image. Moreover, the image maybe scaled up and down, for example, in response to the first user 20's manipulation. Further, when the meeting spot 62 is some kind of facility such as a cafe, information on the name of this facility, for example, may be further superimposed on this image.

By referring to this route guidance information, the first user 20 can smoothly travel to the present location of the second user terminal 10 which is the meeting spot.

Meanwhile, the second user terminal 10 outputs meeting information (Step S13). To this end, the notification unit 112 of the first user terminal 10 retrieves information for creating meeting information 123 from the storage unit 12 of the first user terminal 10 and creates meeting information.

Here, the information for creating meeting information 123 includes information on the first user 20 and information on travel means that the first user 20 uses. The information on the first user 20 indicates information on the image and name of the first user 20, for example.

When the travel means is an automobile, for example, the information on travel means indicates information such as a vehicle category, vehicle type, color, and number. The vehicle category indicates a vehicle category such as a minivan and sedan. The color indicates the exterior color of the automobile. In addition, the number indicates a license number. Meanwhile, when the travel means is a bicycle, for example, the information indicates the kind of the bicycle (such as a city cycle, mountain bike, and hybrid bicycle) and the color of the bicycle. In either case, it is preferable that the information further include information on the exterior image of the travel means.

These sets of information on travel means are provided for the purpose of allowing the users to meet up easily. In particular, it is preferable that the information include information on visual characteristics so that the second user 20 can easily notice the first user 20's arrival at the meeting spot. For example, it is preferable that the information include the information on the vehicle type and color and the information on the exterior image of the travel means as described above.

Here, the travel means of the first user 20 changes from time to time. For example, the user usually travels by an automobile, but sometimes travels by a bicycle or on foot. Hence, it is preferable to let the first user 20 select the travel means to be used to travel to the meeting spot at the time of selecting a person to meet in Step S11, and create meeting information in the case of using the selected travel means in Step S13.

Once cresting meeting information based on information on the first user 20 and information on the travel means of the first user 20, the notification unit 112 of the first user terminal 10 sends the created meeting information to the notification unit 112 of the second user terminal 10.

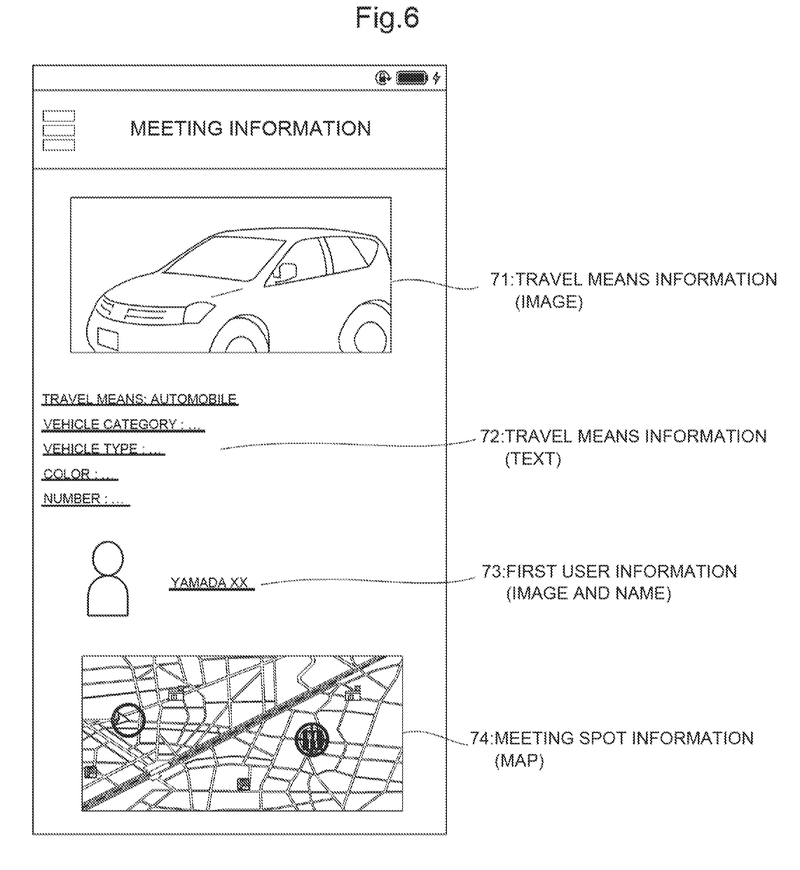

The notification unit 112 of the second user terminal 10 displays the received meeting information on the display unit 15 of the second user terminal 10. A display example of this meeting information is described with reference to FIG. 6.

As illustrated in FIG. 6, the meeting information includes: travel means information 71; travel means information 72; first user information 73; and meeting spot information 74.

Specifically, information on the exterior image of the travel means (automobile in the example of this drawing) is displayed as the travel means information 71. Besides, texts explaining the vehicle category etc. of the travel means are displayed as the travel means information 72. Note that, in the case where the exterior image of the travel means is stored in the first user terminal 10 or in a server or the like that the first user terminal 10 uses, the exterior image of the travel means is included in the meeting information sent by the first user terminal 10, and thus the second user terminal 10 can display this image. On the other hand, in the case where this image is stored neither in the first user terminal 10 nor in a server or the like that the first user terminal 10 uses, it is also possible that the first user terminal 10 or the second user terminal 10 acquires an image of the travel means by searching a network based on the vehicle type name etc. of the travel means and displays the image acquired by this searching.

In addition, information on the image and name of the first user 20 is displayed as the first user information 73. Further, map information is displayed as the meeting spot information 74. The guidance information created in Step S12 can be used as this map information as well. The map information includes the meeting spot as described with reference to FIG. 5. Here, the map information may also include the present location of the first user terminal 10 at the time of creation of the meeting information.

By referring to this meeting information, the second user 20 can know what kind of travel means the first user 20 as the person to meet uses to get to the meeting spot, and thus can find the first user 20 easily when the first user 20 arrives at the meeting spot. In other words, the users can meet up more smoothly than ever.

Next, the notification unit 112 of the first user terminal 10 judges whether or not a stop-off point input operation has been made by the first user 20 (Step S14). If no input operation has been made (No in Step S14), the process proceeds to Step S16. On the other hand, if the input operation has been made (Yes in Step S14), the process proceeds to Step S15. Here, the stop-off point indicates a stop-off point, such as a shop, where the first user 20 stops off on the way to the meeting spot (destination) according to the route guidance processing executed by the guidance unit 111.

Meanwhile, as an example of another idea, the stop-off point may indicate a stop-off point where the user changes its travel means, for example. In the case where the first user 20 traveling by an automobile parks the car at a parking near the meeting spot and then stoves to the destination on foot, for example, this parking may he set as the stop-off point. Alternatively, in the case where the first user 20 moves to the nearest station on foot, travels from the nearest station to a station near the destination by train, and then moves from the station near the destination to the destination on foot, the nearest station and the station near the destination may be each set as the stop-off point.

In Step S15, the first user terminal 10 outputs recommendation information. Here, the recommendation information indicates information for recommending, as a new meeting spot, a spot near the stop-off point and suitable for the users to meet up. For example, the users may be possible to meet up more smoothly if the second user 20 comes to the stop-off point like: a spot on the way to the meeting spot such as a shop; a parking near the meeting spot; the nearest station; and a station near the destination. In such a case, it is sometimes better for the users to meet up at a spot near the stop-off point and suitable for the users to meet up (e.g. cafe and book store) rather than at the stop-off point. Thus, once the stop-off point is set, this embodiment outputs recommendation information in order to recommend such spots.

Recommendation information can be output in such a way that the notification unit 112 of the first user terminal 10 reads the map information 121 from the storage unit 12 of the first user terminal 10, and recommendation information created based on this map information is displayed on the display unit 15 of the first user terminal 10.

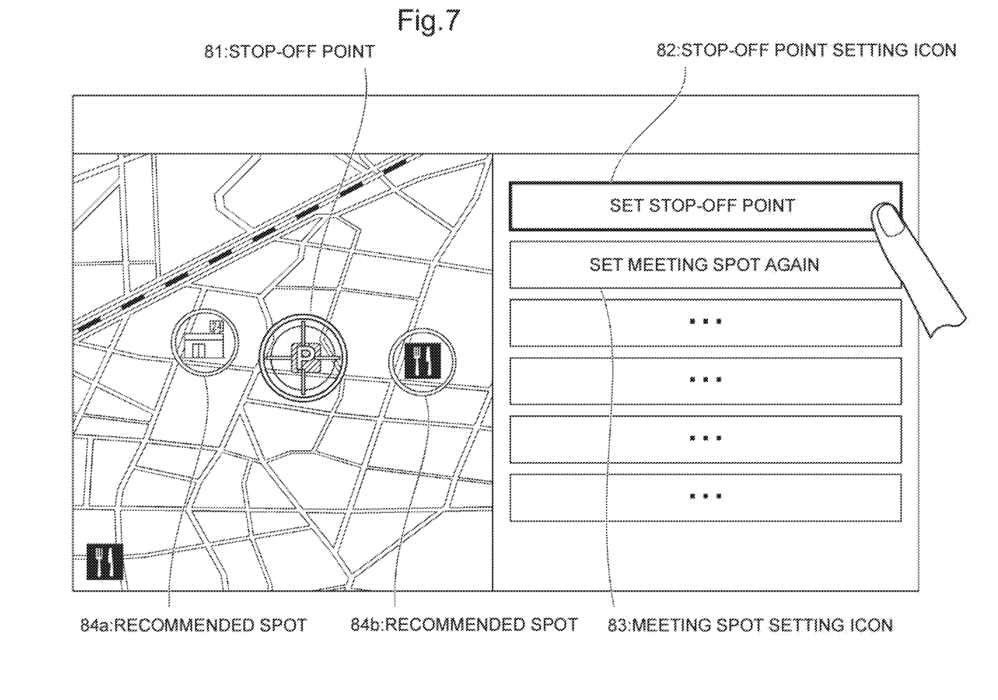

A display example in Steps S14 and S15 is described with reference to FIG. 7. As illustrated in FIG. 7, in this screen, a stop-off point 81, a recommended spot 84a, and a recommended spot 84b are superimposed on the map information. Besides, a stop-off point setting icon 82 and a meeting spot setting icon 83 are also displayed on this screen. When selecting a stop-off point, the first user 20 selects a stop-off point (the stop-off point 81 in this drawing) on the map and presses the stop-off point setting icon 82. Then, the notification unit 112 of the first user terminal 10 sets the stop-off point 81 as the stop-off point (Yes in Step S14). Next, the notification unit 112 of the first user terminal 10 creates recommendation information as described above and displays it on the map (Step S15). This recommendation information is the recommended spot 84a and the recommended spot 84b which are spots near the stop-off point and suitable for the users to meet up.

The first user 20 refers to the recommendation information, and does not do any manipulation if he/she has no intention to set the meeting spot again (No in Step S16). In this case, the process proceeds to Step S13.

On the other hand, when the first user 20 refers to the recommendation information and intends to set the meeting spot again, he/she selects the recommended spot 84a or the recommended spot 84b on the map and presses the meeting spot setting icon 83. Then, the notification unit 112 of the first user terminal 10 sets the selected recommended spot as a new destination (Yes in Step S16).

In this case, the notification unit 112 of the first user terminal 10 causes the first user terminal 10 to output the guidance information as in Step S12 on the basis of the location of the new destination set in Step S16 instead of the present location of the second user 20 (Step S17). In this case, since the second user 20 is also supposed to move to the new destination, the notification unit 112 of the second user terminal 10 causes the second user terminal 10 to output the guidance information like the notification unit 112 of the first user terminal 10 in Step S12 on the basis of the location of the new destination set in Step S16 (Step S17).

By referring to this route guidance information, the first user 20 and the second user 20 can smoothly move to the new destination which is the meeting spot.

Meanwhile, in the case where the travel means of the first user 20 changes at the stop-off point, the notification unit 112 of the first user terminal 10 causes the second user terminal 10 to output the meeting information as in Step S13 on the basis of information on the changed travel means (Step S18). In this case, since the second user 20 is also supposed to move to the new destination, the notification unit 112 of the second user terminal 10 causes the first user terminal 10 to output the meeting information like the notification unit 112 of the first user terminal 10 in Step S13 on the basis of the information on the travel means of the second user 20 (Step S18).

By referring to this meeting information, the first user 20 and the second user 20 can each know what kind of travel means the first user 20 or the second user 20 who is the person to meet uses to come to the meeting spot, and thus the user can find the person to meet easily when the person, to meet arrives at the meeting spot. In other words, they can meet up more smoothly than ever.

Note that the meeting spot can be set again in Step S16 irrespective of whether or not there is an output of the recommendation, information. To put it differently, the meeting spot can be set again even if no input of the stop-off point is made (No in Step s14) and there is no output, of the recommendation information. In addition, a new meeting spot to be set again may be selected from among recommended spots displayed by the recommendation information, or alternatively any location other than the recommended spots may be selected as the new meeting spot.

Further, the meeting spot may be set again by the second user 20's manipulation of the second user terminal 10. In other words, if the second user 20 has enough time, he/she may move to a spot located between the first user 20 and the second user 20. In preparation for such cases, it is preferable that the recommendation information be displayed on the second user terminal 10 as well in Step S15.

Next, it is judged whether a reminder condition is satisfied (Step S19). Here, a reminder indicates a notification prompting the first user or the second user to move to the meeting spot which is the destination. Meanwhile, the reminder condition indicates a condition for reminding the user. If the reminder condition is satisfied (Yes in Step S19), the notification unit 112 of the first user terminal 10 or the second user terminal 10 reminds the user by outputting the reminder information (Step S20). On the other hand, if the reminder information is not satisfied (No in Step S19), no reminder information is output.

The reminder condition and reminder information are described in detail. The notification unit 112 of each user terminal 10 estimates the remaining time required for each user to arrive at the destination with his/her travel means. The estimation is made based on, for example, the expected travelling speed of each travel means and the distance to the destination. For example, when the travel means is a bicycle whose expected travelling speed is 20 kilometers per hour and the distance from the present location to the destination is four kilometers, the remaining time required to arrive at the destination is calculated to be 15 minutes.

Then, it is judged that the reminder condition is satisfied if the time required for the first user 20 to arrive at the destination becomes equal to the time required for the second user 20 to arrive at the destination.

For example, assume a case where the remaining time required for the first user 20 to arrive at the destination was 30 minutes and the remaining time required for the second user 20 to arrive at the destination was 20 minutes when they decided to meet up. In this case, after 10 minutes have passed since the first user 20 starts moving to the destination, both of the remaining time required of the first user and that of the second user become equal (20 minutes). Thus, the notification unit 112 of the second user terminal 10 outputs reminder information to the second user 20. For example, the reminder information is output in such a manner that a text message such as “It's about time to go to the destination” is displayed on the display unit 15, or a voice message such as “It's about time to go to the destination” is output through the microphone.

If the second user 20 starts to go to the destination based on this reminder information, the first user 20 and the second user 20 arrive at the destination at the same time. This can prevent a situation where one of the users 20 has to wait at the destination. In other words, this enables the users to meet up more smoothly than ever.

Note that, if the present location of the second user 20 is set as the destination, no such reminder information needs to be output to the second user 20. For example, if the second user 20 is in a cafe and this cafe is set as the destination, no reminder information needs to be output to the second user 20. On the other hand, if the second user 20 is in a cafe but a parking near the cafe is set as the meeting spot, reminder information can be output to the second user 20 several minutes before the first user 20 arrives at the parking.

Next, in Step S21, the notification unit 112 of the first user terminal 10 and that of the second user terminal 10 each judge whether or not both the first user 20 and the second user 20 have arrived at the destination. The judgment can be made based on whether or not the present location of the first user terminal 10 and that of the second user terminal 10 have become equal to the location of the destination. If both or any of the first user 20 and the second user 20 have not arrived at the destination (No in Step S21), the process goes back to Step S14 and continues from there. On the other hand, if both the first user 20 and the second user 20 have arrived at the destination (Yes in Step S21), the process terminates.

With the meeting information notification processing described above, this embodiment brings about an effect of enabling the users to meet up more smoothly than ever as described above.

<Regarding Hardware and Software>

Note that each of the devices included in the above navigation system can be implemented by hardware, software, or a combination of them. In addition, the navigation method executed by collaboration among the devices included in the above navigation system can also be implemented by hardware, software, or a combination of them. Here, to implement them by software means to implement them by causing a computer to load and execute programs.

Programs can be supplied to a computer while being stored with many types of non-transitory computer readable medium. The non-transitory computer readable medium include many types of tangible storage medium. Examples of the non-transitory computer readable medium include: a magnetic recording medium (e.g. a flexible disk, magnetic tape, and hard disk drive); a magneto-optical recording medium (e.g. a magneto-optical disk); a read only memory (CD-ROM); a CD-R; a CD-R/W; a semiconductor memory (e.g. a mask ROM, programmable ROM (PROM), and erasable PROM (EPROM)); a flash ROM; and a random access memory (RAM). Alternatively, the programs may be supplied to a computer by many types of transitory computer readable medium. Examples of the transitory computer readable medium include: an electrical signal; an optical signal; and an electromagnetic wave. The transitory computer readable medium can supply the programs to a computer via a wire communication channel such as an electrical wire and an optical fiber or a radio communication channel.

### Modified Example

Although the above embodiment is a preferred embodiment of the present invention, the scope of the present invention is not limited to the above embodiment and various modifications can be made thereto without departing from the gist of the present invention.

In the above embodiment, the meeting information notification processing above is executed by the guidance unit 111 and the notification unit 112 of each of the first user terminal 10 and the second user terminal 10. This setting may be modified in such a way that part of or all of the functions of the guidance unit 111 and the notification unit 112 are implemented by another apparatus. For example, part of or all of the functions of the guidance unit 111 and the notification unit 112 may be implemented by a server apparatus (not illustrated) connected to the network 30. For example, this server apparatus may create guidance information and causes the first user terminal 10 to display the created guidance information thereon. Further, when the user selects the second user 20 with the first user terminal 10, the server apparatus may create meeting information and causes the second user terminal 10 to display the created meeting information thereon.

In addition, in the above embodiment, each of the first user terminal 10 and the second user terminal 10 is a terminal which is portable by being installed in a movable body or a mobile terminal which is portable by being carried, by a user. However, if users are to meet up at the home, company, etc. of the second user terminal 10, the second user terminal 10 may be implemented by a stationary terminal such as a desktop personal computer.

Moreover, the above embodiment may be utilized for three or more users to meet up. In this case, this is implemented by a first user 20 selecting multiple second users 20 and performing the above processing to each of second user terminals 10 of the multiple second users 20.

Further, the user terminals 10 may be implemented in a form not illustrated in FIG. 1. For example, the above description states that, if the user terminal 10 is an in-vehicle unit like the user terminal 10a, it is implemented by an in-vehicle device installed in a movable body, such as a car navigation system. On the other hand, the description states that, if the user terminal 10 is a mobile terminal like the user terminal 10b or the user terminal 10c, it is implemented by a mobile device such as a smartphone.

In addition to these configurations, the user terminal 10 may be implemented by a collaboration of an in-vehicle device and a mobile device. In this case, the following case is conceivable as an example. Specifically, the in-vehicle device and the mobile device are connected to each other so that they can exchange information via radio communications compliant with standards such as Wi-Fi, Near Field Communication (NFC), and Bluetooth (registered trademark) or wire communications by way of a universal serial bus (USB) cable or the like.

In this state, the mobile device is remotely controlled by manipulation of the in-vehicle device. Further, the mobile device sends sound and image information to the in-vehicle device.

Then, the in-vehicle device receives the sound and image information, and reproduces and displays the received sound and image information on a display unit of the in-vehicle device. As another example, it is also conceivable that the in-vehicle device receives sound and image information, and reproduces and displays, on the display unit of the in-vehicle device, sound and image information obtained by combining the received sound and image information and information of the in-vehicle device. In this case, for example, it is conceivable that the mobile device sends information on the present locations of the first user 20 and the second user 20 to the in-vehicle device, and the in-vehicle device superimposes the received present locations on map information created by the in-vehicle device and displays it thereon.

1. A navigation system comprising:
a guidance unit configured to set, when a first user selects a second user whom said first user plans to meet, a destination which is any of a location of said selected second user and a location in a vicinity of said selected second user and to provide, to said first user, guidance information for guiding said first user to said destination, said first user utilizing travel means for traveling to said destination; and
a notification unit, configured to notify, when said destination is set, said second user of information indicating characteristics belonging to said first user's travel means such that said second user can recognize said first user based on said information of the characteristics belonging to said first user's travel means when said first user arrives at the destination.

2. The navigation system according to claim 1, wherein said information of the characteristics belonging to said travel means comprises visible characteristics of said travel means.

3. The navigation system according to claim 1, wherein,
said guidance unit is further configured to set a stop-off point located on a traveling route: to said destination, and
said notification unit notifies either of or both of said first user and said second user of recommendation information indicating a recommended location suitable for said first and second users to meet in a vicinity of said stop-off point.

4. The navigation system according to claim 3, wherein said stop-off point is a location located on said route by which said first user gets to said destination and is the location at which said first user changes said travel means to different travel means.

5. The navigation system according to claim 3, wherein, when said recommended location in the vicinity of said stop-off point is set as a new destination,
said guidance unit provides, to said first user, said guidance information for guiding said first user to said new destination and provides, to said second user, guidance information for guiding said second user to said new destination, said second user utilizing travel means for traveling to said new location, and
said notification unit provides, to said first user, information indicating characteristics belonging to said second user's travel means and provides, to said second user, said information indicating the characteristics belonging to said first user's travel means.

6. The navigation system according to claim 5, wherein, when said guidance unit guides each of said first and second users to said destination,
said notification unit estimate a first length of time required for said first user to arrive at said destination and a second length of time required for said second user to arrive at said destination, one of said first length of time and said second length of time becoming shorter as the corresponding user is traveling, and
said notification unit provides, to the other of the users, a notification encouraging the other to travel to said destination when said first length of time required for said first user to arrive at said destination becomes equal to said second length of time required for said second user to arrive at said destination.

7. A user terminal operable by a first user, the user terminal comprising:
a guidance unit configured to set, when said first user selects a second user whom said first user plans to meet, a destination which is any of a location of said selected second user and a location in a vicinity of said selected second user and to provide, to said first user, guidance information for guiding said first user to said destination, said first user utilizing travel means for traveling to said destination; and
a notification unit configured to send, when said destination is set, to a second user terminal operable by said second user, information indicating characteristics belonging to said first user's travel means, thereby allowing the second user terminal to notify said second user of said information indicating the characteristics belonging to said first user's travel means such that said second user can recognize said first user based on said information of the characteristics belonging to said first user's travel means when said first user arrives at the destination.

8. A navigation method comprising:
a guidance step of setting, when a first user selects a second user whom said first user plans to meet, a destination which is any of a location of said selected second user and a location in a vicinity of said selected second user and to provide, to said first user, guidance information for guiding said first user to said destination, said first user utilizing travel means for traveling to said destination; and
a notification step of outputting, when said destination is set, information indicating characteristics belonging to said first user's travel means such that said second user can recognize said first user based on said information of the characteristics belonging to said first user's travel means when said first user arrives at the destination.
